(19) United States
(12) Patent Application Publication
(10) Pub. No.: US 2004/0056557 A1
(43) Pub. Date: Mar. 25, 2004

(54) Epicycloidal motor

(76) Inventors: Yuji Enomoto, Hitachi (JP); Toshimi Abukawa, Hitachiota (JP); Tomoko Abukawa, Hitachiota (JP); Yasuaki Motegi, Sano (JP); Sachio Hatori, Kiryuu (JP); Takashi Ando, Kiryuu (JP)

Correspondence Address: CROWELL & MORING LLP, INTELLECTUAL PROPERTY GROUP, P.O. BOX 14300, WASHINGTON, DC, 20044-4300, US

(21) Appl. No.: 10/620,760

(22) Filed: Jul. 17, 2003

(30) Foreign Application Priority Data
Jul. 22, 2002 (JP) 2002-212066

(51) Int. Cl. H02K 1/00; H02K 1/28; H02K 1/18

(52) U.S. Cl. 310/218; 310/216; 310/259

(57) ABSTRACT

(Subject) The present invention clarifies the stator core configuration and winding specifications required to ensure that the stator formed by assembling the split cores of an epicycloidal motor exhibits the optimum performances, and provides a high-efficiency compact-sized motor.

(Means for Solving the Problems)

An epicycloidal motor having a stator core formed by assembling multiple split core pieces, and a stator winding conductor wound in the stator core slot, wherein the ratio of the overall effective area of the conductor (including the coating of an insulator, etc.) relative to the effective sectional area of the slot is 0.5 through 0.8.

### BACKGROUND OF THE INVENTION

1. Field of the Invention

The present invention relates to the structure of a stator core in a compact-sized, high-torque epicycloidal motor including a fan motor and disk drive motor.

2. Prior Art

To improve the winding space factor, the hypocycloidal motor stator is designed in such a structure that the stator core is split for each pole, and the split cores are connected with one another by laser welding, or are press-fit or shrinkage-fit into the housing whose inner periphery is cylindrical. This structure has been in the main stream.

However, the stator of the epicycloidal motor is so designed that the magnetic pole as its tee (split core piece) is arranged in a radial form from the inner periphery to the outer periphery, and a magnetic gap with the magnet rotor is formed on the outer periphery. This makes it difficult to connect one spit core piece with another. Further, such a member as a housing cannot be press-fit or shrinkage-fit from the outer periphery. This has also made it difficult to adopt the split core method in an epicycloidal motor stator and winding type direct current motor rotor where stator core is split and assembled.

The prior art on the structure where this epicycloidal motor stator core is split has been disclosed in the Japanese Patent Application No. 2001-239142 (Japanese Application Patent Laid-Open Publication No. 2003-52139) and Japanese Patent Application No. 2001 380830 (Japanese Application Patent Laid-Open Publication No. 2003-189514). The stator according to these Publications is designed in such a structure that the stator core of the epicycloidal motor is split into multiple parts in the circumferential direction. Each of the split core pieces is provided with a concave or convex portion in a dovetail tenon form on the inner periphery. The housing arranged on the inner periphery of the split core piece is provided with the concave or convex portion fitting with the split core piece. The housing is subjected to shrinkage fitting. The dimensions of the fit portion are determined in such a way that a gap for assembling is formed on the fitting portion when expanded by heat before shrinkage fit.

When the split core method of the epicycloidal motor is used, there is a greater freedom in the motor designing than when the conventional integral core is used. In the design of a conventional epicycloidal motor according to the prior art example, however, consideration has not been given to splitting of the core. This has failed to adopt the motor structure optimum to the split core.

### SUMMARY OF THE INVENTION

(Problems to be Solved by the Invention)

In the above-mentioned prior art, use of the split core structure for the epicycloidal motor is estimated to improve the space factor of the winding, and compact configuration is considered to be achieved by the improvement of torque and heat radiation. However, optimization of motor characteristics using a split core has not been carried out. There has been no clear explanation on the differences in the mechanism for the occurrence of loss from that of an integral one. Further, there has been no reference to the motor structure that permits the limit design area to be achieved.

In the case of an integral core, winding cannot be wound on the tee slot portion. Accordingly, winding is performed by slipping a wire into the slot open groove from the tip of the tee i.e. outer periphery, or by passing a winding nozzle having a diameter greater than that of the wire into open groove of slot inlet. Since these methods depend on the procedure of slipping of a wire, winding tends to be irregular, with the result that wires cross each other and space factor is reduced. When the winding method based on a winding nozzle is used, it is necessary to secure the portion for accommodating the nozzle having a diameter greater than that of the wire in the final stage. This leaves a waste gap corresponding to that amount, and reduces the winding space factor. Accordingly, the space factor as a percentage of the cross section of the wire including the coasting in the area of the slot that permits winding, i.e. the area obtained by subtracting the cross section of the insulator from that of the slot is 50% or less in the winding of an integral core.

The motor using the split core stator where the core is split and reassembled allows the winding space factor to be improved. Further, winding is performed before assembling of the split core and stator, and this allows desired setting of the slot open dimensions, independently of the wire diameter or winding nozzle diameter. In the case of the conventional motor, however, it has been difficult to carry out evaluation by tentative creation of a motor having a small gap for accommodating the wire. As a result, such motor characteristics have not been known. Lack of a database has made it impossible to examine the optimum design structure of a split core stator motor.

To solve the above-mentioned problems, the object of the present invention is to clarify the stator core configuration and winding specifications required to ensure that the stator produced by assembling the split core pieces of an epicycloidal motor exhibits the optimum performances, and to provide a high-efficiency compact-sized motor.

(Means for Solving the Problems)

To achieve the above-mentioned object, the present invention provides an epicycloidal motor having a stator winding conductor wound in the stator core slot, wherein the ratio of the overall effective area of said conductor (including the coating of an insulator, etc.) to the effective sectional area of the slot is 0.5 through 0.8.

This invention improves the space factor or occupancy rate of the conductor relative to the slot, and reduces the copper loss of the motor, whereby improving motor characteristics.

To put it more specifically, in addition to the above-mentioned ration (0.5 through 0.8), the outer periphery of the tee flange is formed in a circular arc, and a flat inclination is provided on both ends of the outer periphery, where the ratio of the range angle of the flat inclination viewed from the stator core center relative to the range angle of the circular arc viewed from the stator core center is 0.2 through 0.75. Further, the ratio of the open angle of the slot inlet as the gap between the ends of adjacent tee flanges is viewed from the stator core center, relative to the angle in the arrangement interval of the tee is 0.04 through 0.3. Still further, the ratio of the thickness of the rotor magnet in the axial direction along the axial direction of the rotary shaft of the rotor relative to the thickness of the rotor core in the axial direction is 0.6 through 0.9. Furthermore, residual stress subsequent to connection where the adjacent tee bases are pressed against each other by connection to the housing does not exceed 50 MPa. Still further, the ratio of the angle of the tee column width as the width of the tee column on the end of the outer periphery is viewed from the center of the stator core, relative to the angle in the arrangement interval of the tee, is 0.18 to 0.34. Still further, the magnetic pole sensor is located at the position shifted by an electric angle of 10 to 20 degrees in the direction of current running from the reference line extending through the center of the slot.

When the profile of the stator core and specifications of the stator winding have been determined in the above-mentioned manner, the motor characteristics can be maximized. The optimum motor configuration for the split core can be achieved by application of the numeral gained from the result of examining the relationship between each parameter of the motor and motor characteristics (efficiency) using a method similar to robust designing method, in order to determine the profile of the stator core and specifications of the motor winding.

### BRIEF DESCRIPTION OF THE DRAWINGS

FIG. 1 is a drawing representing the basic configuration of an epicycloidal motor using a split stator core as an embodiment of the present invention;

FIG. 2 is a drawing illustrating the space factor of the winding on the stator core of an epicycloidal motor as an embodiment of the present invention;

FIG. 3 is a drawing representing the result of experiment to examine the relationship between the parameter on configuration of the stator core of an epicycloidal motor and motor efficiency, as an embodiment of the present invention;

FIG. 4 is an explanatory drawing representing the differences in tee flange configurations, as an embodiment of the present invention;

FIG. 5 is an explanatory drawing representing the result of experiment that shows the relationship between the ratio of the range angle of the circular arc of a tee flange relative to the range angle of a flat inclination and the motor cogging torque, as an embodiment of the present invention;

FIG. 6 is a explanatory drawing representing the result of experiment that shows the relationship between the ratio of the angle in the arrangement interval of a tee relative to the open angle of the slot inlet, inductance and induced voltage, as an embodiment of the present invention;

FIG. 7 is an explanatory drawing representing the result of experiment that shows the relationship between the ratio of the thickness of the stator core layer of an epicycloidal motor relative to the length of a rotor magnet in the axial direction, as an embodiment of the present invention;

FIG. 8 is an explanatory drawing representing the result of experiment that shows the relationship between the thickness of the stator core layer of an epicycloidal motor and motor efficiency, as an embodiment of the present invention;

FIG. 9 is a explanatory drawing representing the result of experiment that shows the relationship between the end width of the tee column on the outer periphery, the angle in the arrangement interval of the tee and motor efficiency, as an embodiment of the present invention; and

FIG. 10 is an explanatory drawing representing the result of experiment that shows the relationship between the position of the magnetic pole position sensor and motor efficiency, as an embodiment of the present invention.

### DETAILED DESCRIPTION OF THE INVENTION

(Description of the Preferred Embodiments)

The following describes the preferred embodiments of the present invention with reference to drawings:

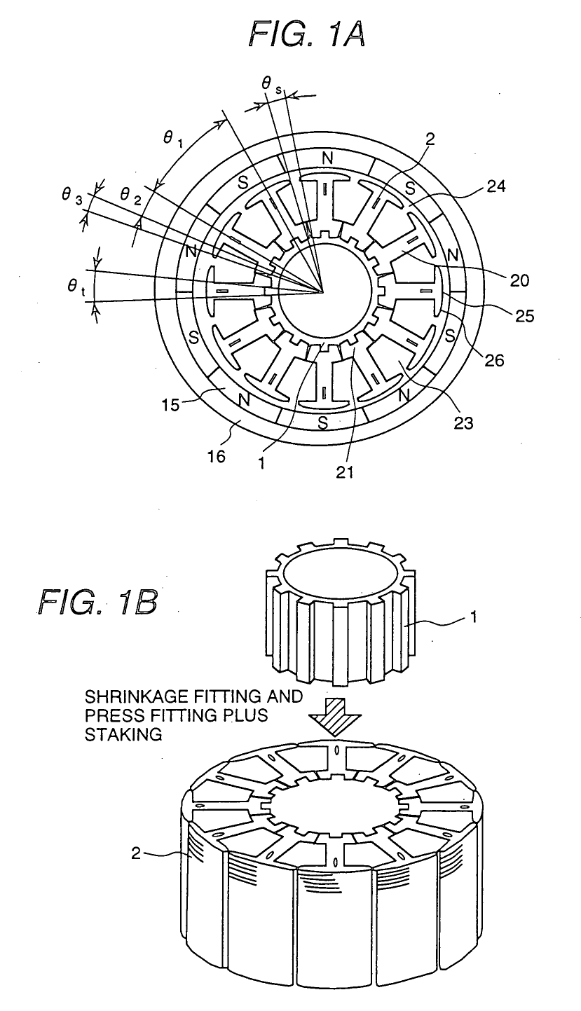

FIG. 1 shows the structure of a basic epicycloidal motor stator core as an embodiment of the present invention. In this example, the rotor magnet has ten poles and the stator core has twelve poles. The stator core is designed in such a structure that the stator core 2 of the epicycloidal motor is split in multiple parts in the circumferential direction. Each of the split core pieces has a concave fitting portion 2a on the inner periphery, and a cylindrical housing 1 arranged on the inner periphery of the split piece is provided with a convex fitting portion 1a that fits into one side of the split core.

The following describes further details of this stator core:

The stator core 2 is formed of a combination of multiple split core pieces.

Each split core piece becomes a tee as a magnetic pole of the stator core. Each tee contains a tee base, a tee column extending along the periphery from this tee base, and a tee flange extending in the circumferential direction on both sides of the tip of said tee column.

The tee column has the same width from the end on the inner periphery (tee base side) to the end on the outer periphery (tee flange side). The conductor of the stator winding (circular cross section) is wound on the tee on the front, with the split core pieces assembled. The difference from the integral stator core is that the conductor can be wound directly around the tee column, so it is wound in a regular winding form. Since winding is not irregular, the conductor of the stator winding is accommodated in a slot in a regular winding form without any waste space.

FIG. 1(a) is a perspective view explaining the assembling of an epicycloidal motor stator and a housing.

Assembling is accomplished by connecting between the tee base of each split core piece and housing 1. A dovetail tenon structure is formed on the connection between the tee base and housing 1, thereby ensuring rigid connection.

The housing 1 is assembled with the stator core 2 by shrinkage fitting. Before shrinkage fitting, the temperature of only the housing 1 is raised by a heating furnace or the similar means. With its temperature kept higher than that of the stator core 2, the housing 1 is fitted to the stator core 2. In this example, the housing is made of aluminum as a material characterized by high expansion. The housing material is preferred to have a higher coefficient of linear expansion than the iron that is the material of the stator core, and to have a relatively high mechanical strength. For example, aluminum alloy, zinc alloy and magnesium are preferred, but the material is not restricted to them alone. The housing after shrinkage fitting is continued to be provided with stress that causes the housing to shrink in the inner peripheral direction to be back to the original dimension. This has the effect of pulling the split core 2 toward the inner diameter side. This effect clamps the cores (adjacent tee bases) so that they press against each other.

The outer periphery of the tee flange of this stator core 2 is formed in a circular arc and a flat inclination is formed on both ends of the outer periphery. This flat inclination tends to be closer to the center of the stator core 2 as one goes closer to the end. The outer periphery of the tee flange has its center formed in a circular arc, and a flat inclination is formed on both ends.

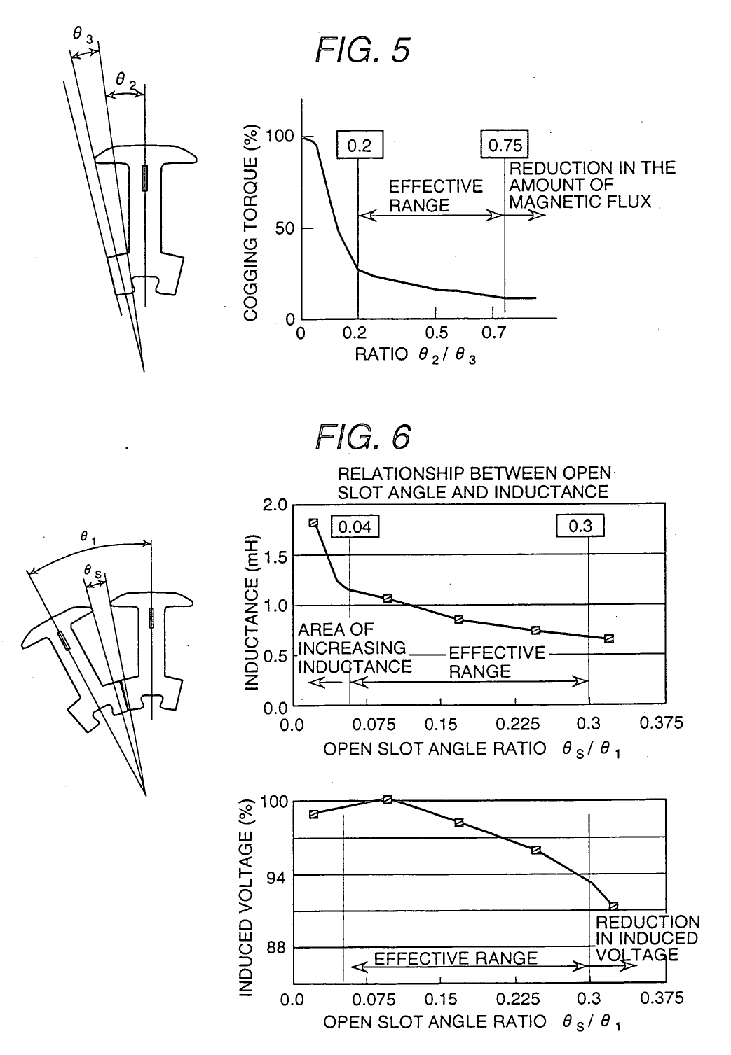

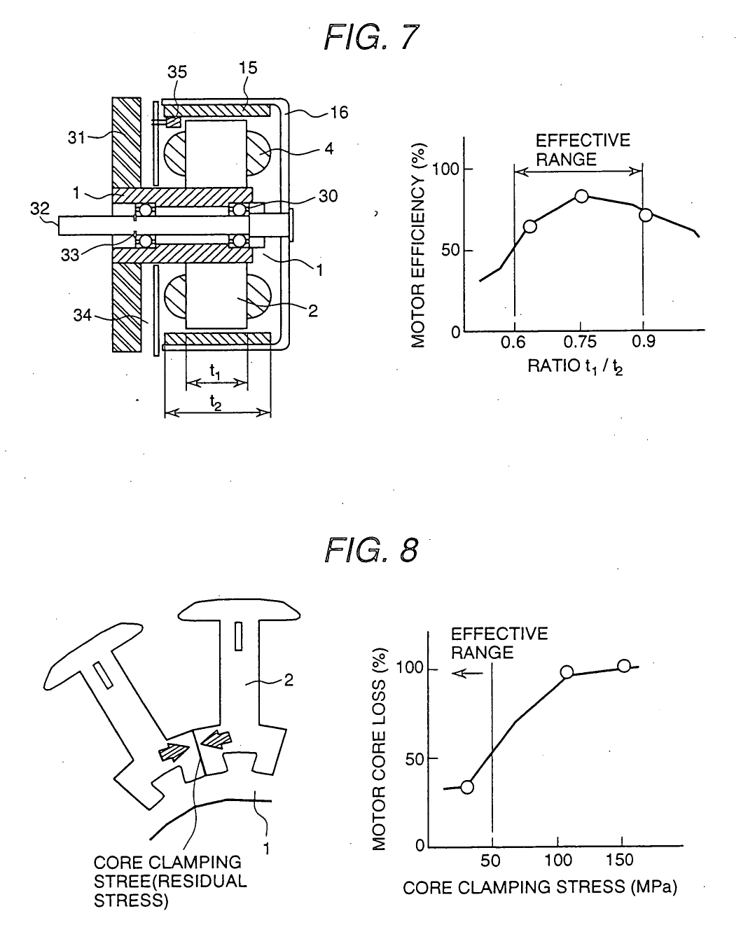

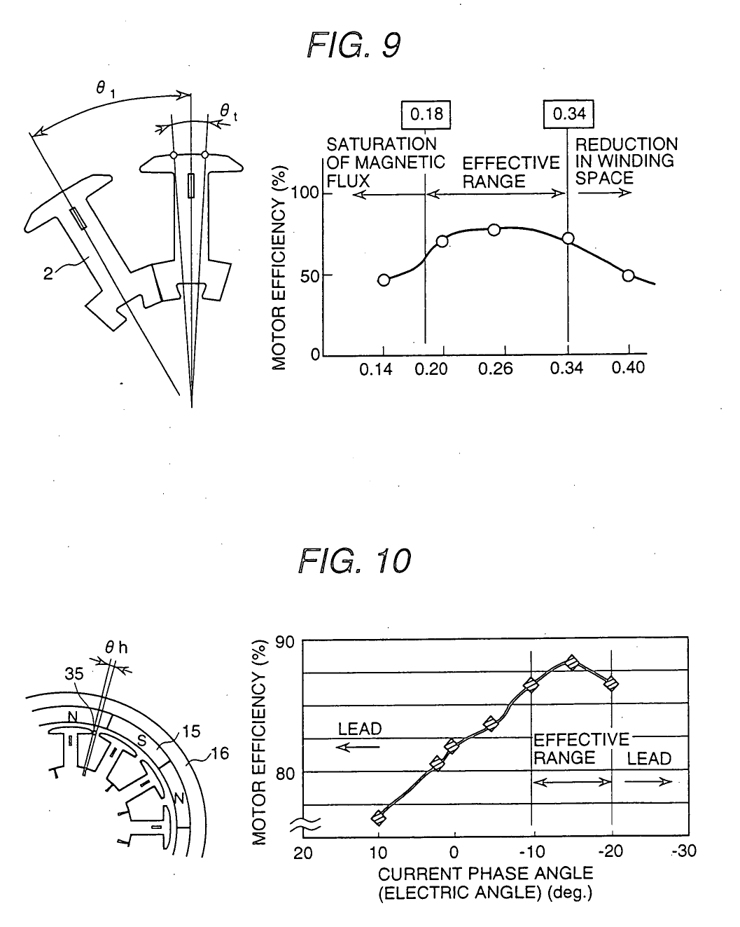

As shown in FIG. 5, the ratio of the range angle (θ₃) (one side of the flat inclination) of the flat inclination viewed from the center of the stator core 2 relative to the range angle (θ₂) (half the circular arc) of the circular arc viewed from the stator core center is 0.7 through 0.75. Further, as shown in FIG. 6, the ratio of the open angle of the slot inlet (θₛ) as the gap between the ends of adjacent tee flanges is viewed from the stator core center, relative to the angle in the arrangement interval of the tee (θ₁) is 0.04 through 0.3. As shown in FIG. 7, the ratio of the thickness of the stator core in the axial direction along the axial direction of the rotary shaft of the rotor (t₁) relative to the thickness of the rotor magnet in the axial direction (t₂) is 0.6 through 0.9. Furthermore, as shown in FIG. 8, residual stress subsequent to connection where the adjacent tee bases are pressed against each other by connection to the housing does not exceed 50 MPa. Still further, as shown in FIG. 9, the ratio of the angle of the tee column width (θₜ) as the width of the tee column on the end of the outer periphery is viewed from the center of the stator core, relative to the angle in the arrangement interval of the tee (θ₁), is 0.18 to 0.34.

The following describes the detailed dimensions of the split stator core according to the result of experiment:

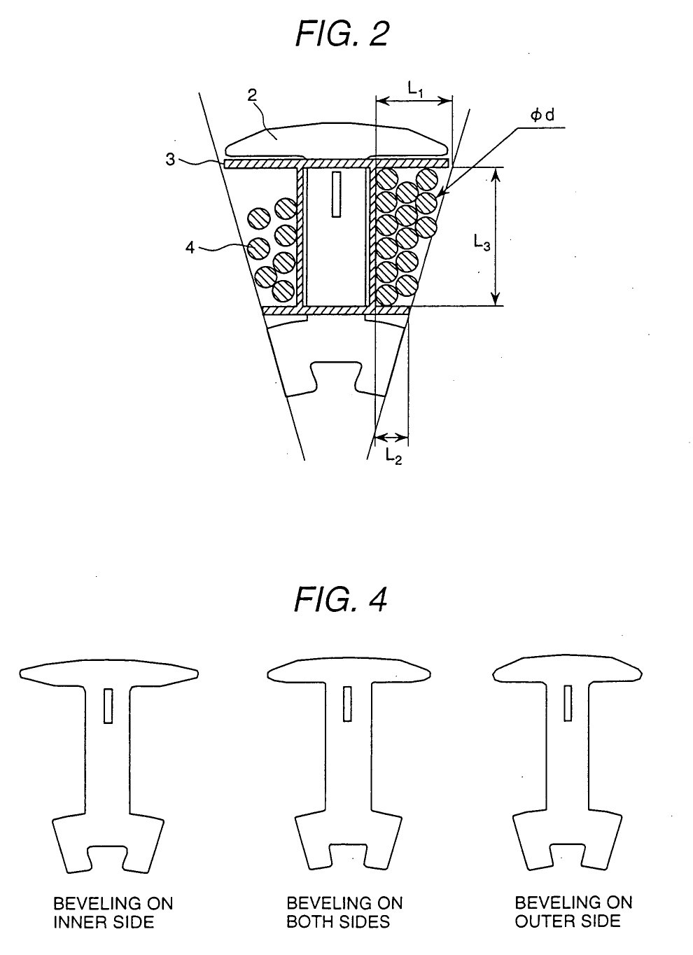

The following describes the space factor of the stator winding on the slot with reference to FIG. 2: Normally, the winding on the stator core is provided by placing such an insulator as a winding bobbin to cover the surface of the tee arranged on the core. In this case, the area where winding can be formed (effective sectional area) is obtained by subtracting the cross section of the insulator from that of the core slot. It is given by the denominator of equation 1.

$$S \cdot F \cdot = \frac{N \cdot π {d}^{2} / 4}{( {L}_{1} + {L}_{2} ) {L}_{3} / 2} \qquad [ Eq . 1 ]$$

where N: denotes the number of turns.

Further, the overall effective cross section of the winding (including the insulator covering the conductor) becomes the one indicated by the numerator of Eq. 1. If its ratio to the area where winding can be formed is defined as a space factor (S.F.), then calculation can be made using the Eq. 1.

These space factors of winding are reduced when the conventional integral stator core (non-split core) is used. In the integral stator core, winding is performed by slipping a conductor (wire) between the adjacent tee flanges (i.e. the open groove of slot inlet) or by passing a winding nozzle having a diameter greater than that of the wire into the open groove of slot inlet). Accordingly, the wire cannot be wound directly on the tee slot, and winding becomes irregular, with the result that wires cross each other and space factor is reduced due to increased waste space.

When the winding method based on a winding nozzle is used, it is necessary to secure the portion for accommodating the nozzle having a diameter greater than that of the wire in the final stage. This increases the waste space (gap) corresponding to that amount, and reduces the winding space factor. Thus, the space factor as a percentage of the cross section of the wire (overall effective area) including the coasting in the area of the slot that permits winding, i.e. the area obtained by subtracting the cross section of the insulator from that of the slot is 50% or less in the winding of an integral core.

Using the method of splitting the stator core, the present invention has made it possible to wind a wire in a regular form of winding by stacking, as shown by the slot on the right side of FIG. 2. This is expected to provide a high space factor. However, in the case of a round wire (a conductor having a circular cross section), a gap between wires remains when regular winding is formed by stacking, so there is a theoretical limit, which is about 0.8.

The actual motor slot contains a gap required for assembling between the insulator such as a bobbin and stator core, and includes positions having such a trapezoidal form that wire cannot be mounted thereon, so the value is reduced to below 0.8. However, in order to reach the theoretical value where possible, the space factor is set at 0.8.

The winding space factor of 0.5 through 0.8 that could not be obtained in the conventional integral stator core has been realized, and this ensures a motor efficiency higher than that of the integral core. In this case, the number of turns and wire diameter vary according to the motor speed and current capacity. If the number of turns is smaller, the wire diameter is increased wherever possible so that the space factor can be set within the above-mentioned range. This procedure allows the resistance and copper loss to be reduced, and provides a highly efficient motor.

The following describes the motor efficiency:

Motor efficiency η=output(W)/input(W)

Output(W)=input(W)−loss

Loss=copper loss+core loss

Copper loss=I²R

−R∝SF (winding space factor)

The above-mentioned equation shows that copper loss is reduced as the winding space factor (SF) is increased, with the result that motor efficiency is increased.

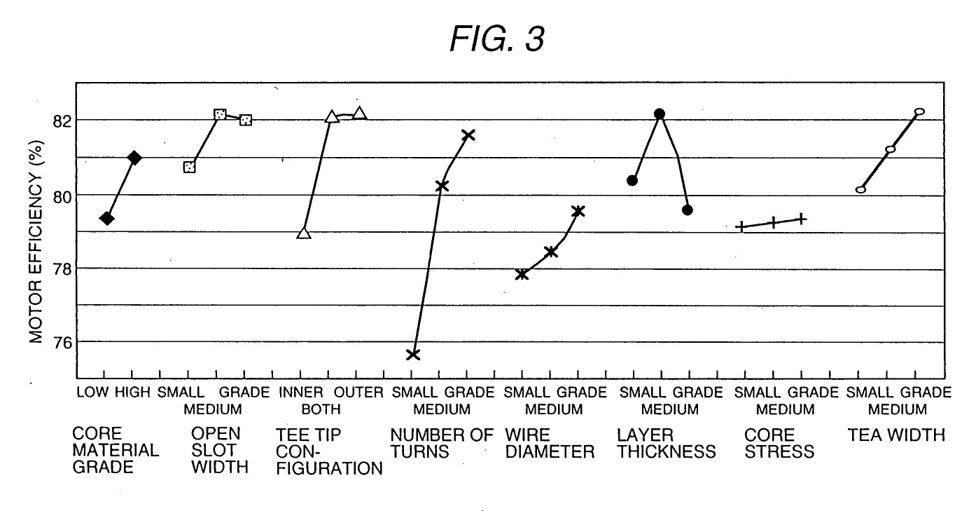

FIG. 3 shows the result of experiment where motor efficiency is evaluated by changing conceivable parameters. This result of experiment shows the effect of each parameter independently of others. The core material of higher grade, i.e. the material considered to have a low core loss value, tends to provide higher motor efficiency.

The open slot width (open angle at slot inlet) exhibits a peak in the result of characteristics; namely, the optimum values considered to lie between medium and great widths.

To evaluate the tee flange configuration, we have picked up three types of configurations shown in FIG. 4, and examined them. It has been revealed that higher efficiency is obtained by a flat inclination arranged on both sides outside the beveling on inner side (inner flat inclination). It has also been verified that higher efficiency is obtained by a greater number of turns and greater wire diameter. This suggests that improvement of the space factor is synonymous with improvement of efficiency. The result of the experiment further shows that there is a peak in the thickness of the stator core stacked in the axial direction, suggesting that the maximum value is present. Still further, it has been shown that a higher motor efficiency is given by a lower residual stress resulting from clamping of the split cores constituting the stator core, i.e. the tee bases of the tees (adjacent tee bases pressing against each other), and higher efficiency is provided by greater width of the tee column.

Since each parameter provides each effect, high motor efficiency can be provided by optimization of these parameters.

The following describes the further details of the high efficiency of a motor:

The configuration of the tee flange will be shown with reference to FIG. 5: FIG. 3 shows that the outer beveling is effective in improving efficiency, as described above. Smaller cogging torque is an important factor as one of the characteristics of affecting the motor quality.

The open angle θ2 at the circular arc of the outer periphery when the outer beveling is provided (range angle of the circular arc as viewed from the stator core center) has been compared with the angle θ3 of the flat inclination (range angle of the flat inclination as viewed from the stator core center). Then relationship between the ratio and cogging has been examined.

There is a sudden reduction in cogging torque when this ratio ranges from 0 to 0.2, and a slow reduction is observed as the ratio increases from 0.2. Thus, to ensure that the cogging torque is reduced, the ratio of θ2/θ3 is preferred to be 0.2 or more. However, if this ratio is too big, it will lead to reduction in the amount of magnetic flux entering the magnetic pole. So this ratio cannot be increased very much. Thus, the upper limit has been determined at the level of 0.75, which ensures the amount of magnetic flux required to keep the efficiency higher than that of the motor having an integral stator core. It has been determined that this ratio is preferred to be 0.2 through 0.75.

The slot angle (width) at the slot open inlet will be described. As shown in FIG. 6, parameters are related to the inductance and induced voltage. According to the trend given in FIG. 3, it has been determined that the maximum value is found in the medium range without being excessive. According to FIG. 6 representing the relationship between inductance and induced voltage, the optimum value is found when the ratio of Os (slot angle at open inlet when the gap between the tee flange ends is viewed from the stator core center)/θ1 (angle in the arrangement interval of the tee) is 0.04 through 0.3. If inductance is increased, invalid current will occur to torque, resulting in a loss. To avoid this, the inductance is set to a small value to ensure a higher induced voltage, and this is more effective in allowing torque to occur. Thus, it is important to keep a good balance between the two.

The thickness t1 of the stator core in the axial direction is shorter than the length of the rotor magnet in the axial direction. The maximum value in this case is obtained when the t1/t2 is in the range from 0.6 through 0.9, as shown in FIG. 7. The stress in the clamping of the core (stress where the adjacent tee bases press against each other) is necessary for clamping. However, if it is excessive, increase in core loss will be caused by stress strain. The result of experiment shows that a substantial increase of the core loss can be avoided by setting the residual stress at 50 MPa or less.

Further, as shown in FIG. 9, high motor efficiency can be obtained when the angle θ₁ of the magnetic pole of the stator core (angle of the tee column width as the end width of the tee column on the outer periphery is viewed from the stator core center) is set within the range from 0.18 through 0.34 with respect to the pitch angle of magnetic pile θₜ (angle in the arrangement interval of the tee).

In addition, when the stator is mounted on the control board and the motor is assembled, a rotor magnetic pole positing sensor is generally arranged at the center of the slot to serve as a switch to change over the current when the motor is driven. Experiment has been made on the assumption that this position also has the maximum value. FIG. 10 shows the result. It reveals that a high degree of robustness and efficiency can be ensured when the magnetic pole sensor is located at the position shifted by an electric angle (θh) of 10 to 20 degrees in the direction of current running from the reference line extending through the center of the slot. Thus, this positional relationship has been adopted for the epicycloidal motor based on a split core.

As described above, the present invention ensures a high level of strength, precision and reliability without sacrificing the motor performance, and provides an economical epicycloidal motor characterized by very small cogging torque.

Further, improved space factor of the winding permits more compact motor designing. In addition, less heat generation of coil and higher heat conductivity are conducive to the production of an epicycloidal motor characterized by more improved temperature characteristics. Since the core is formed in a split structure, a drastic improvement of the yield from core material can be achieved, whereby an economical motor is produced at a reduced material cost.

(Effects of the Invention)

The present invention provides a split core motor characterized by excellent motor performances.

What is claimed is:

1. An epicycloidal motor comprising a stator core formed by a combination of multiple split core pieces, and a stator winding conductor wound on the slot of said stator core, wherein the ratio of the overall effective area of said conductor (including the coating of an insulator, etc.) to the effective sectional area of said slot is 0.5 through 0.8.

2. An epicycloidal motor according to claim 1 characterized in that a tee as said split core piece comprises:
a tee base;
a tee column extending along the periphery from said tee base; and
a tee flange extending in the circumferential direction on both sides of the tip of said tee column;
said motor further characterized in that said slots are formed on the inner periphery of the tee flange and on both sides of the tee column, and the outer periphery of said tee flange is formed in a circular arc and flat inclinations are arranged on both ends of the outer periphery.

3. An epicycloidal motor according to claim 2 characterized in that the ratio of the range angle of said flat inclination as viewed from the center of said stator core relative to the range angle of said circular arc as viewed from the center of said stator core is 0.2 through 0.75.

4. An epicycloidal motor according to claim 1 characterized in that tee as said split core piece comprises:
a tee base;
a tee column extending along the periphery from said tee base; and
a tee flange extending in the circumferential direction on both sides of the tip of said tee column;
said motor further characterized in that said slots are formed on the inner periphery of the tee flange and on both sides of the tee column; and the ratio of the open angle of the slot inlet as the gap between the ends of adjacent tee flanges is viewed from the center of said stator core, relative to the angle in the arrangement interval of said tee is 0.04 through 0.3.

5. An epicycloidal motor according to claim 1 characterized by further comprising:
a rotor rotating on the outer periphery of the stator core; and
a rotor magnet arranged face to face with the outer periphery of the stator core;
wherein the ratio of the thickness of the rotor magnet in the axial direction along the axial direction of the rotary shaft of the rotor relative to the thickness of said stator core in the axial direction is 0.6 through 0.9.

6. An epicycloidal motor according to claim 1 characterized by further comprising an annular housing connecting said split core piece, wherein a tee as split core piece comprises:
a tee base;
a tee column extending along the periphery from said tee base; and
a tee flange extending in the circumferential direction on both sides of the tip of said tee column;
said motor further characterized in that said slots are formed on the inner periphery of the tee flange and on both sides of the tee column, and residual stress subsequent to connection where said adjacent tee bases are pressed against each other by connection to said housing-does not exceed 50 MPa.

7. An epicycloidal motor comprising a stator core formed by a combination of multiple split core pieces, and a stator winding conductor wound on the slot of said stator core, wherein a tee as split core piece comprises:
a tee base;
a tee column extending along the periphery from said tee base; and
a tee flange extending in the circumferential direction on both sides of the tip of said tee column;
said motor further characterized in that:
said slots are formed on the inner periphery of the tee flange and on both sides of the tee column;
the ratio of the angle of the tee column width as the width of said tee column on the end of the outer periphery is viewed from the center of said stator core, relative to the angle in the arrangement interval of said tee is 0.18 to 0.34; and
the ratio of the overall effective area of said conductor (including the coating of an insulator, etc.) to the effective sectional area of said slot is 0.5 through 0.8.

8. An epicycloidal motor comprising:
a stator core formed by a combination of multiple split core pieces;
a stator winding conductor wound on the slot of said stator core;
a rotor rotating on the outer periphery of the fixed core;
a rotor magnet provided on said rotor and arranged to face the outer periphery of the stator core; and
a magnetic pole sensor such as a hall element for detecting the magnetic pole position of said rotor magnet;
said motor further characterized in that said magnetic pole sensor is located at the position shifted by an electric angle of 10 to 20 degrees in the direction of current running from the reference line extending through the center of said slot; and the ratio of the overall effective area of said conductor (including the coating of an insulator, etc.) to the effective sectional area of said slot is 0.5 through 0.8.

9. An epicycloidal motor according to claim 1 characterized in that said conductor has a cross section of a circular form, and is wound on the slot in a regular winding method.

10. An epicycloidal motor according to claim 2 characterized in that said conductor has a cross section of a circular form, and is wound on the slot in a regular winding method.

11. An epicycloidal motor according to claim 3 characterized in that said conductor has a cross section of a circular form, and is wound on the slot in a regular winding method.

12. An epicycloidal motor according to claim 4 characterized in that said conductor has a cross section of a circular form, and is wound on the slot in a regular winding method.

13. An epicycloidal motor according to claim 5 characterized in that said conductor has a cross section of a circular form, and is wound on the slot in a regular winding method.

14. An epicycloidal motor according to claim 6 characterized in that said conductor has a cross section of a circular form, and is wound on the slot in a regular winding method.

15. An epicycloidal motor according to claim 7 characterized in that said conductor has a cross section of a circular form, and is wound on the slot in a regular winding method.

16. An epicycloidal motor according to claim 8 characterized in that said conductor has a cross section of a circular form, and is wound on the slot in a regular winding method.
